(19) United States
(12) Patent Application Publication
(10) Pub. No.: US 2024/0308593 A1
(43) Pub. Date: Sep. 19, 2024

(54) ROCKER ASSEMBLY WITH TAPERED STIFFENING INSERT

(71) Applicant: Shape Corp., Grand Haven, MI (US)

(72) Inventor: Matthew Kuipers, Holland, MI (US)

(21) Appl. No.: 18/606,748

(22) Filed: Mar. 15, 2024

Related U.S. Application Data
(60) Provisional application No. 63/452,692, filed on Mar. 16, 2023.

(51) Int. Cl. B62D 25/02; B62D 21/15

(52) U.S. Cl. CPC B62D 25/025; B62D 21/157

(57) ABSTRACT

A vehicle rocker assembly includes a sill structure having an inboard wall and an outboard wall defining an elongated hollow interior therebetween. The rocker assembly also includes a rocker insert that extends along the elongated hollow interior of the sill structure. The rocker insert includes a stiffening member that has a metal sheet defining a wave-shaped structure that includes upper wall sections, lower wall sections, and bulkhead wall sections integrally extending between the upper and lower wall sections. The bulkhead wall sections have a tapered shaped between an inner edge of the metal sheet facing the inboard wall of the sill structure and an outer edge of the metal sheet that faces the outboard wall of the sill structure.

### CROSS-REFERENCE TO RELATED APPLICATION

This application claims the benefit and priority under 35 U.S.C. § 119(e) of U.S. provisional application Ser. No. 63/452,692, filed on Mar. 16, 2023, the content of which is incorporated herein by reference in its entirety.

### TECHNICAL FIELD

The present disclosure relates to vehicle structural members and reinforcement beams, and more particularly relates to components, such as rocker assembles, battery trays, and other vehicle frame structures or the like.

### BACKGROUND

Vehicle frames and body structures are designed to support the vehicle and undergo and absorb certain levels of impact forces, such as to prevent distances of inboard intrusion into the vehicle in accordance with insurance requirements and other regulatory and legal requirements. Side impacts to a vehicle are commonly tested with side pole impact testing, which direct significant side impact forces to the vehicle. Vehicle frames primarily absorb these side impacts at rocker sections that run longitudinally between the front and rear wheels along the lower outboard portions of the vehicle frame.

With the incorporation of battery trays in electric and hybrid electric vehicles in the lateral inboard area between opposing rocker sections, it is desirable for the side impact forces to be mitigated to reduce the associated intrusion distance from the side impact. For example, it is generally known to increase stiffness of a vehicle sill assembly, such as by adding a rocker insert within the vehicle sill assembly.

### SUMMARY

The disclosure provides a vehicle structural component, such as a rocker component or rocker assembly, that includes a beam structure defining an elongated hollow interior, such as a hollow sill structure. The sill structure may be formed with a sill inner and a sill outer that together surround the elongated hollow interior. A rocker insert is located along the elongated hollow interior of the beam or still structure. The rocker insert includes a stiffening member that is formed with a metal sheet, where the metal sheet defines a wave-shaped structure having by a series of upper wall sections, lower wall sections, and upright or bulkhead wall sections interconnecting the upper and lower wall sections. The bulkhead wall sections have a tapered shaped between an inner edge of the metal sheet facing the inboard wall of the sill structure and an outer edge of the metal sheet that faces the outboard wall of the sill structure. The tapered shaped bulkhead wall sections provide improved load path distribution and impact energy absorption at an outboard side of the beam structure. The tapered shape and enclosed wave-shaped structure, among other features of the structure, also provides enhanced resistance to side impact intrusion along the length of the rocker assembly.

According to one aspect of the disclosure, a vehicle rocker assembly includes a sill structure having an inboard wall and an outboard wall defining an elongated hollow interior therebetween. The rocker assembly also includes a rocker insert that extends along the elongated hollow interior of the sill structure. The rocker insert includes a stiffening member that has a metal sheet defining a wave-shaped structure that includes upper wall sections, lower wall sections, and bulkhead wall sections integrally extending between the upper and lower wall sections. The bulkhead wall sections have a tapered shaped between an inner edge of the metal sheet facing the inboard wall of the sill structure and an outer edge of the metal sheet that faces the outboard wall of the sill structure.

In some examples, the inner edges of the bulkhead wall sections have a height dimension that is greater than a height dimension of the outer edges of the bulkhead wall sections. The upper and lower wall sections, in some implementations, have an opposing tapered shaped that is opposite in the direction of taper from the tapered shape of the bulkhead wall sections, such that the upper and lower wall sections taper from the outer edge of the metal sheet to the inner edge of the metal sheet.

Also, in some examples, the stiffening member includes a rib that extends in a direction parallel to the length of the rocker insert, such as along an upper wall section, a lower wall section, or a bulkhead wall section. The rib, in some implementations, extends on the bulkhead wall section in a direction between the upper and lower wall sections in parallel with the outer edge of the metal sheet that faces the outboard wall of the sill structure. In some examples, the rib is an elongated embossment for stiffening the respective bulkhead wall section. In other examples, the rib is provided as a crush initiation feature. Further, in some implementations, the bulkhead wall sections include two or more ribs that extend in parallel between the upper and lower wall section.

In some examples, the bulkhead wall sections integrally extend from the upper wall section and angle away from each other. Also, in some examples, the bulkhead wall sections integrally extend from the lower wall section and angle away from each other. The bulkhead wall sections, in some implementations, extend at an angle from the interconnected upper and lower wall sections that is greater than 90 degrees.

Moreover, in some examples, the rocker insert also includes an elongated support member that attaches along the upper wall sections and/or the lower wall sections of the stiffening member. The elongated support member may, in some instances, have a top wall that attaches along the upper wall sections of the stiffening member and a bottom wall that attaches along the lower wall sections of the stiffening member. Also, the elongated support member may, in some examples, have a top wall that interfaces along the upper wall sections of the stiffening member and a side wall that interfaces along the outer edges of the bulkhead wall sections of the stiffening member. Further, the elongated support member may, in some examples, have a top wall, a side wall, and a bottom wall that are integrally connected to define a channel, where the stiffening member is disposed along the channel, such that the top and bottom walls of the elongated support member are angled from each other to conform to the tapered shape of the bulkhead wall sections.

According to another aspect of the disclosure, a rocker assembly for a vehicle includes a sill structure that has an inboard wall and an outboard wall defining an elongated hollow interior therebetween. The rocker assembly also has a rocker insert extending along the elongated hollow interior of the sill structure. The rocker insert incudes an elongated support member having a top wall section, a side wall section, and a bottom wall section defining a channel. The rocker insert also includes a stiffening member disposed in the channel. The stiffening member is formed with a metal sheet defining a wave-shaped structure that includes bulkhead wall sections integrally extending between the top and bottom wall sections. The bulkhead wall sections have a tapered shaped from an inner edge of the metal sheet to an outer edge of the metal sheet that interfaces with the side wall section of the elongated support member.

According to yet another aspect of the disclosure, a rocker insert is provided that is disposed within an elongated hollow interior defined between a sill inner and a sill outer. The rocker insert includes a stiffening member having a metal sheet that includes integrally connected upper wall sections, lower wall sections, and bulkhead wall sections that are divided by bends so as to define a wave-shaped structure. The adjacent pairs of the bulkhead wall sections extend away from each other at an angle from the upper and lower wall sections that is greater than 90 degrees. The bulkhead wall sections have a tapered shaped between an inner edge of the metal sheet facing the inboard wall of the sill structure and an outer edge of the metal sheet that faces the outboard wall of the sill structure.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is an side elevation view of a vehicle schematically showing a rocker assembly and a battery tray enclosure;

FIG. 2 is a perspective view of a vehicle schematically showing a rocker assembly and other structural components;

FIG. 3 is a cross-sectional view of an example of a vehicle rocker assembly including a rocker insert;

FIG. 4 is a perspective view of the rocker insert shown in FIG. 3;

FIG. 5 is a perspective view of the rocker insert taken from the opposing side from that shown in FIG. 4;

FIG. 6 is a side view of the rocker insert shown in FIG. 4;

FIG. 6A is an enlarged view of the rocker insert taken at section A shown in FIG. 6;

FIG. 7 is an end view of the rocker insert shown in FIG. 4;

FIG. 8 is a perspective, cross-sectional view of the rocker insert taken at line IIX-IIX shown in FIG. 7;

FIG. 8A is an enlarged perspective view of the rocker insert taken at section A shown in FIG. 8;

FIG. 9 is a perspective view of the stiffening member of the rocker insert; and

FIG. 9A is an enlarged perspective view of the stiffening member taken at section A shown in FIG. 9.

Like reference numerals indicate like parts throughout the drawings.

### DETAILED DESCRIPTION

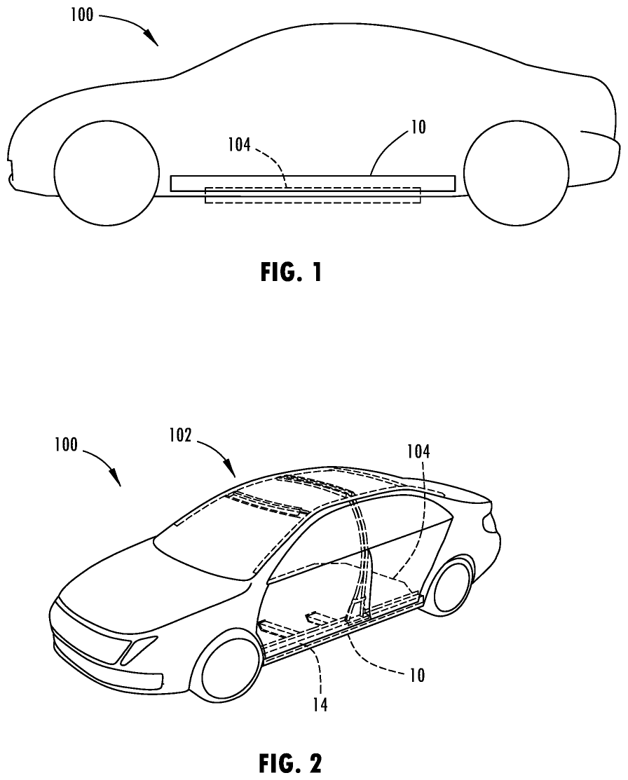

Referring now to the drawings and the illustrative embodiments depicted therein, a beam component is provided for a vehicle 100, such as for a body structure or frame 102 as shown in FIGS. 1 and 2. The vehicle frame 102 and associated components may have various designs and configurations, such as for different styles and types of vehicles. As shown for example in FIGS. 1 and 2, the vehicle frame 102 has various structural components, including a B-pillar, a hinge pillar, a floor cross-member, a roof bow, and a header, among other structural components that support the body of the vehicle and protect passengers, engine components, and sensitive electronics from damage when undergoing collisions. As also shown in FIGS. 1 and 2, the vehicle may be operated by a propulsion system that uses a battery, such as a battery or battery modules that may be supported in a battery tray 104 generally located between the axles and below the floor to distribute the battery weight and establish a low center of gravity for the vehicle.

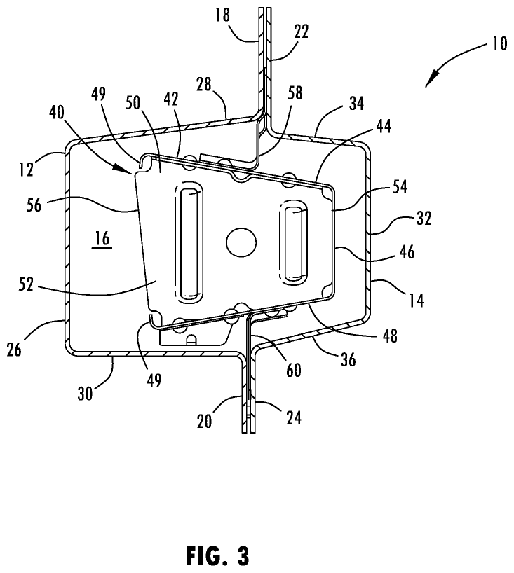

The beam component disclosed herein may be a longitudinally oriented structural beam, such as a rocker component or a battery tray side member, or another structural component that would benefit from some or all the impact energy management properties provided by the beam component or implementations thereof. As shown in FIG. 3, the vehicle rocker component and associated parts, which is referred to as a rocker assembly 10, includes a sill structure having a panel or panels. The sill structure shown in FIG. 3 has a sill inner 12 and sill outer 14 that attach together to surround an interior area along the length of the sill structure, defining an elongated hollow interior 16. In reference to sill inner and sill outer, the terms “inner” and “outer” are made in reference to inboard or inward facing and outboard or outward facing directions on the vehicle, such oriented in FIG. 2. As shown in FIG. 3, the example of the vehicle rocker assembly 10 is also provided with a rocker insert 40 disposed in the hollow interior 16 to form a reinforced rocker structure. The rocker insert may also be referred to as a reinforcement insert, such as in implementations of beam components outside of or disassociated with a rocker assembly. The rocker assembly 10 shown in FIG. 2 is disposed alongside an outer section of a battery tray 104 with the floor cross-member being attached to the vehicle rocker assembly 10 so as to span laterally over the battery tray 104. Accordingly, the beam component in additional implementations may also or alternatively be provided as a battery tray frame component, such as a longitudinally oriented side wall section of the battery tray.

Referring now to the vehicle rocker assembly 10 shown in FIG. 3, the sill inner 12 has an upper flange 18 and a lower flange 20 that extend along respective upper and lower edges of the sill inner 12. The sill inner 12 protrudes inboard from the upper and lower flanges 18, 20 to form an outward facing concave structure. The sill outer 14 has a C-shaped cross section with flanges 22, 24, which may be referred to as an upper flange 22 and a lower flange 24. The upper flanges 18, 22 and the lower flanges 20, 24 of the sill inner 12 and sill outer 14 are attached together, such as via welding, with the concave structures facing each other. The upper and lower flanges 18, 20, 22, 24 of each of the sill panels 12, 14 shown in FIG. 3 extend longitudinally, continuously along the edges of the rocker component; however, it is contemplated that the flanges may be trimmed away in select areas to facilitate frame attachment or to reduce weight.

As further shown in FIG. 3, the sill inner 12 and sill outer 14 are joined together to surround or otherwise define an elongated hollow interior 16 between the sill panels 12, 14. The upper and lower flanges 18, 20, 22, 24 are substantially planar and oriented in a vertical or substantially vertical configuration, such as to mate in generally continuous contact along the length of the rocker assembly. The upper and lower flanges 18, 20, 22, 24 may be joined together via welding, and preferably spot welding, although it is conceivable that alternative welding methods or joining means may be used in addition or in the alternative to spot welding in different implementations of a sill structure, such as adhesive or fasteners or the like.

The sill inner 12 of the vehicle rocker assembly 10 shown in FIG. 3 has an inner wall 26 that is substantially planar. The inner wall 26 integrally interconnects with corner transitions to an upper wall 28 and a lower wall 30 at its respective upper and lower ends. In the example shown in FIG. 3, the corner transition is angled at approximately 90 degrees between the inner wall 26 and the lower wall 30 and the corner transition is angled at approximately 100 degrees between the inner wall 26 and the upper wall 28. Similarly, the upper and lower walls 28, 30 each have a corner transition angled at approximately 90 degrees to the upper flange 18 and the lower flange 20, respectively. In additional examples, the corner transitions may be angled greater or less than the example shown in FIG. 3, such as approximately between 40 and 120 degrees, between 70 and 100 degrees, or between 80 and 95 degrees. The corner transitions are also defined by longitudinal and continuous bends in the sheet material that forms the sill inner 12, such as bends imparted by a roll forming process or progressive stamping process. The sheet material may be a metal sheet, such as a high strength or ultra-high strength steel sheet or aluminum sheet. As also shown in FIG. 3, the upper and lower flanges 18, 20 are substantially planar and oriented in approximately parallel alignment with the planar extent of the inner wall 26. The upper and lower walls 28, 30 of the sill inner 12 may also be substantially planar and substantially parallel to each other or slightly angled from each other, such as shown in FIG. 3.

As also shown in FIG. 3, the sill outer 14 of the vehicle rocker assembly 10 has an outer wall 32 that is substantially planar and integrally interconnects with corner transitions to an upper wall 34 and a lower wall 36 at its respective upper and lower ends. The corner transitions between the outer wall 32 and the upper and lower walls 34, 36 are defined by longitudinal and continuous bends to the sheet material that forms the sill outer 14. The sheet material may be the same or different from the sill inner 12 and may include a metal sheet, such as an advanced high strength steel sheet or aluminum sheet. Similarly, the upper wall 34 also has a corner transition to the upper flange 22 and the lower wall 36 has a corner transition to the lower flange 24, which are each also defined by longitudinal and continuous bends in the sheet material of the sill outer 14. The corner transitions of the sill outer 14 are angled at approximately 90 degrees, and in additional examples may be angled greater or less, such as approximately between 40 and 120 degrees, between 70 and 100 degrees, or between 80 and 95 degrees.

With further reference to sill structure, as shown in FIG. 3 the upper and lower flanges 22, 24 are substantially planar and oriented in parallel alignment with the planar extent of the outer wall 32. The upper and lower walls 34, 36 of the second sill panel 14 are also substantially planar, but are slightly angled from being orthogonal to the outer wall 32 and the flanges 22, 24. With the flanges 18, 20, 22, 24 of the panels 12, 14 attached together, the walls thereof define a substantially rectangular or hexagonal cross-sectional shape; however, it is appreciated that additional examples of the rocker insert may have various alternative cross-sectional shapes and different wall configurations for the corresponding vehicle design (e.g., portions of the inner or outer walls may not be vertically oriented). It is also contemplated that in other examples the sill outer and sill inner may each include different configurations and features, such as having ribs, darts, access holes, or the like.

The vehicle rocker assembly 10, such as shown in FIG. 3, includes a rocker insert 40 disposed within and extending along the elongated hollow interior 16 of the sill structure 12, 14. As shown in FIG. 3, the rocker insert 40 is suspended in the hollow interior 16 of the sill structure in a generally axially centered position. The rocker insert 40 is supported with brackets 58, 60 that attach to the sill structure, such as with welding, fasteners, adhesives, or a combination thereof. In additional examples, the rocker insert may be welded or otherwise affixed directly to the sill structure, such as to a flange and/or wall of at least one of the sill panels.

In the example shown in FIGS. 3-8A, the rocker insert 40 includes an elongated support member 42 and a stiffening member 50 supported by the elongated support member 42. As shown in FIG. 3, the elongated support member 42 has a top wall section 44, a side wall section 46, and a bottom wall section 48 that are integrally connected to define a C-shape cross-sectional shape. The top, side, and bottom wall sections 44, 46, 48 together define a channel along the length of the support member 42, such as shown in FIG. 3, with the open side of the channel facing inboard. As also shown in FIGS. 3-7, the top and bottom wall sections 44, 48 each have a lip 49 at the inboard edge that curves in toward the channel. The top and bottom wall sections 44, 48 are angled from each other to form a tapered shape that is taller at the inboard side and shorter at the outboard side. The stiffening member 50 is disposed along the channel of the elongated supported member 42. In additional examples, the support member may have a different cross-sectional shape along the length, such as an L-shape or other non-tapered shape.

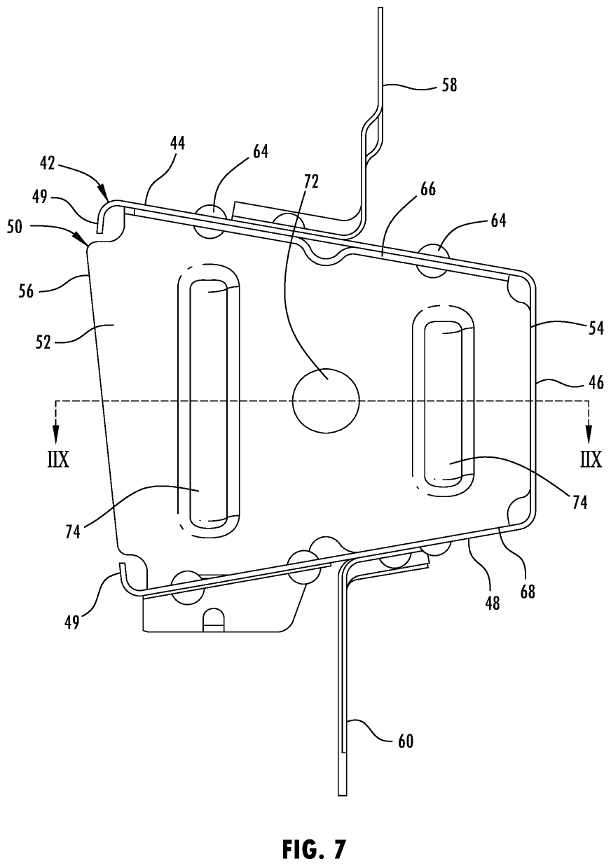

As shown in FIGS. 5-7, the stiffening member 50 is formed with a metal sheet to define a wave-shaped structure that includes bulkhead wall sections 52 that integrally extend between the top and bottom wall sections 66, 68 of the stiffening member 50 that together form the wave-shaped structure. The bulkhead wall sections 52 are generally planar and are positioned to be in generally parallel alignment with potential lateral impact forces, such as to undergo axially loading of side impact forces. As shown in FIG. 7, the bulkhead wall sections 52 have a tapered shaped between an outer edge 54 of the metal sheet that interfaces with the side wall section 46 of the elongated support member 42 and an inner edge 56 of the metal sheet that generally aligns with the inboard edges of the top and bottom wall sections 44, 48.

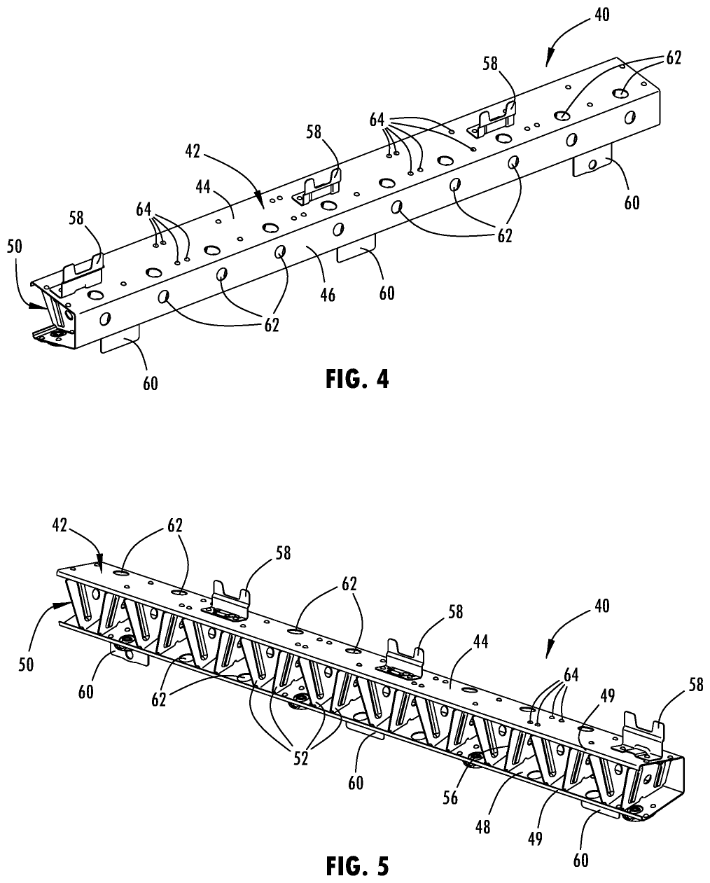

Referring again to FIG. 3, the rocker insert 40 is suspended in the elongated hollow interior 16 of the rocker structure, such that the elongated support member 42 and the supported stiffening member 50 are spaced from the interior surfaces of the sill inner 12 and sill outer 14. To support the rocker insert 40 in the hollow interior 16, the rocker assembly 10 includes upper brackets 58 and lower brackets 60 that are attached respectively between the upper flanges 18, 22 and the lower flanges 20, 24 of the sill structure. As shown in FIGS. 4 and 5, the three upper brackets 58 are spaced along the length of the rocker insert 40 with a lower portion welded to the top surface of the top wall section 44. The brackets 58 also have an upper portion located and secured between the upper flanges 18, 22 (FIG. 3), where the upper portion is angled relative to the lower portion of the bracket. Similarly, the three lower brackets 60 are spaced along the length of the rocker insert 40 with a lower portion located and secured between the lower flanges 20, 24 (FIG. 3) and an upper portion angled relative to the lower portion and welded to the bottom surface of the bottom wall section 48.

In additional examples, there may be more or fewer upper and lower brackets, the upper and/or lower brackets may be arranged differently or otherwise omitted, such as with the elongated support member including an integral attachment flange or the sill structure having an attachment feature or surface to directly attach the rocker insert to the sill structure. As such, it is also contemplated that in additional examples the rocker insert may be positioned against a portion of the sill structure, such as against the inner wall 26 and/or outer wall 32 of the sill structure. Further, the rocker insert 40 occupies at least 50% of the width between the outer sill 14 and the inner sill 12; however, in additional examples, the rocker insert may occupy a lesser or greater percentage of the width, such as greater than 70% or greater than 80% or greater than 90% of the width between the inner and outer sills.

As further shown in FIGS. 4 and 5, the elongated support member 42 includes access holes 62 formed along its length in the top wall section 44, side wall section 46, and bottom wall section 48. The access holes 62 provide openings for attaching the stiffening member 50 in the channel formed by the C-shape of the elongated support member 42. For example, the access holes 62 provide an area for a tool to enter the interior of the channel, such as to position, support, and/or attach the stiffening member 50 to the elongated support member 42. The access holes 46 also reduce mass with the removal of material. Further, as shown in FIGS. 4 and 5, the welds 64 that attach the stiffening member 50 to the elongated support member 42 are formed on the top wall section 44 and the bottom wall section 48 at locations that vertically align with the top and bottom wall sections 66, 68 of the stiffening member 50. The welds 64 may be formed with spot welding, laser welding, induction welding, or the like. In other examples, alternative joining means may be used in addition or in the alternative to welding, such as adhesive or mechanical fasteners or the like.

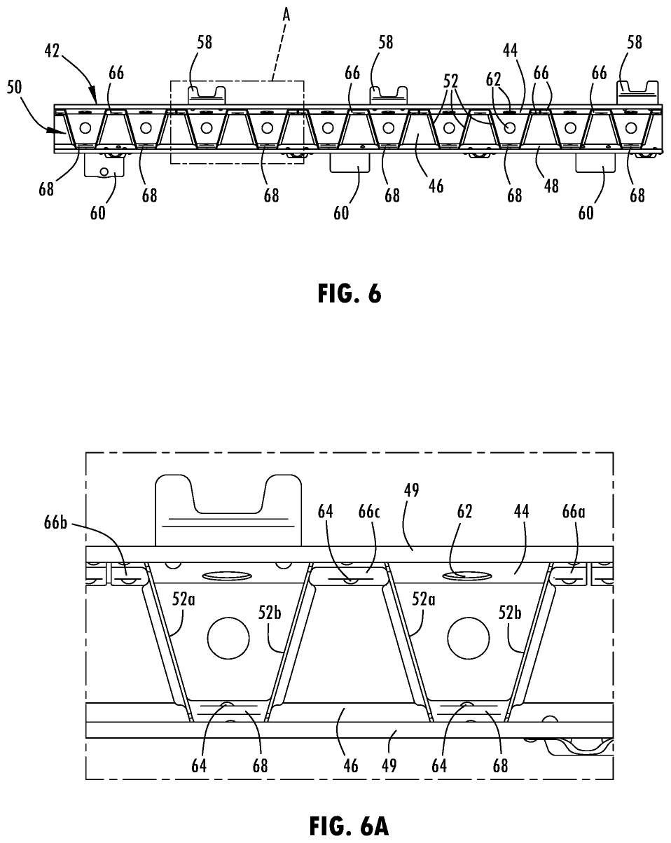

As shown in FIGS. 6 and 6A, the stiffening member 50 is provided by a wave-shaped structure that is formed by a metal sheet to provide upper wall sections 66, lower wall sections 68, and the bulkhead wall sections 52 that integrally extending between the upper and lower wall sections 66, 68. In the example shown in FIGS. 4-7, the upper wall sections 66 are attached at the top wall section 44 and the lower wall sections 68 are attached at the bottom wall section 48 of the elongated support member 42. As shown in FIG. 6A, the undulating wave-shape of the stiffening member 50 is formed by one set of the bulkhead wall sections 52a extending downward from forward ends of the upper wall sections 66 at a slightly forward angle and another set of the bulkhead wall sections 52b extending downward from rearward ends of the upper wall sections 66 at a slightly rearward angle. Likewise, one set of the bulkhead wall sections 52a extend upward from rearward ends of the lower wall sections 68 at a slightly rearward angle and the other set of the bulkhead wall sections 52b extend upward from forward ends of the lower wall sections 68 at a slightly forward angle. The sets of bulkhead wall sections 52a, 52b thereby alternate along the length of the stiffening member 50 so as to provide the wave-shaped structure.

As also shown in FIGS. 6 and 6A, the bulkhead wall sections 52 integrally extend at an angle from the interconnected upper and lower wall sections. The bulkhead wall sections 52 extend from the interconnected upper and lower wall sections 66, 68 at an angle of greater than 90 degrees or an angle between 90 and 140 degrees or an angle between 100 and 130 degrees, such as shown in FIG. 6A as an angle of approximately 120 degrees. In additional examples, the angle between the bulkhead wall sections and the upper and lower wall section may be greater or small and/or may vary at different bulkhead wall sections along the length of the rocker insert.

As further shown in FIGS. 6 and 6A, the stiffening member 50 includes a series of metal sheets that each have a wave-shaped structure and that are arranged end-to-end along the length of the channel formed by the elongated support member 42. The stiffening member 50 shown in FIGS. 6 and 6A has five metal sheets that each have four bulkhead wall sections 52, three upper wall sections 66, and two lower wall sections 68. The metal sheets each form a wave-shaped structure that is generally W-shaped, such as shown in FIG. 6A, where the upper wall sections 66a, 66b at the respective forward and rearward ends of the metal sheets have a length that is approximately half the length of the upper wall section 66c at the center of the metal sheet. In additional examples, a single metal sheet may be used for the stiffening member along the entire length of the elongated support member. For example, a single metal sheet may be stamped in a press/die that is much shorter than the part itself. In this case the part would be moved through the press, similar to a progressive die, hitting it 2-4 times or more to create the completed part. Alternatively, with the use of the repeating series of metal sheets along the length of the elongated support member, the metal sheets may each be identically stamped, such as in a single die.

As shown in FIG. 7, the bulkhead wall sections 52 have a tapered shape between an outer edge 54 of the metal sheet facing the outboard wall 32 of the sill structure and an inner edge 56 of the metal sheet that faces the inboard wall 26 of the sill structure (FIG. 3). As a result of the tapered shape, the inner edges 56 of the bulkhead wall sections 52 have a height dimension that is greater than a height dimension of the outer edges 54 of the bulkhead wall sections. The tapered shape is further defined by the upper portion of the bulkhead wall section forming a bend that transitions into the upper wall sections 66 of the stiffening member 50, where the bend at the upper portion of the bulkhead wall section is angled downward from the inboard side to the outboard side. Similarly, the lower portion of the bulkhead wall section forms a bend that transitions into the lower wall sections 68 of the stiffening member 50, where the bend at the lower portion of the bulkhead wall section is angled upward from the inboard side to the outboard side.

As a result of the angled bends at the upper and lower portions of the bulkhead wall sections 52, as shown in FIG. 7, the upper and lower wall sections 66, 68 have a planar shape that interfaces with and follows the planar interior surfaces of the respective top and bottom wall sections 44, 48. The angled bends thereby position the upper wall sections 66, lower wall sections 68, and the bulkhead wall sections 52 of the stiffening member 50 to further define the tapered shape of the stiffening member 50. The outer edge 54 of the metal sheet may also be located within the channel of the elongated support member 42, such as shown in FIG. 7 where the outer edge 54 of the bulkhead wall sections 52 interfaces with the side wall 46 of the elongated support member to provide a direct load path and a secure fit of the stiffening member 50 in elongated support member 42. In additional examples, the elongated support member may additionally or alternatively interface with the inner edge of the metal sheet.

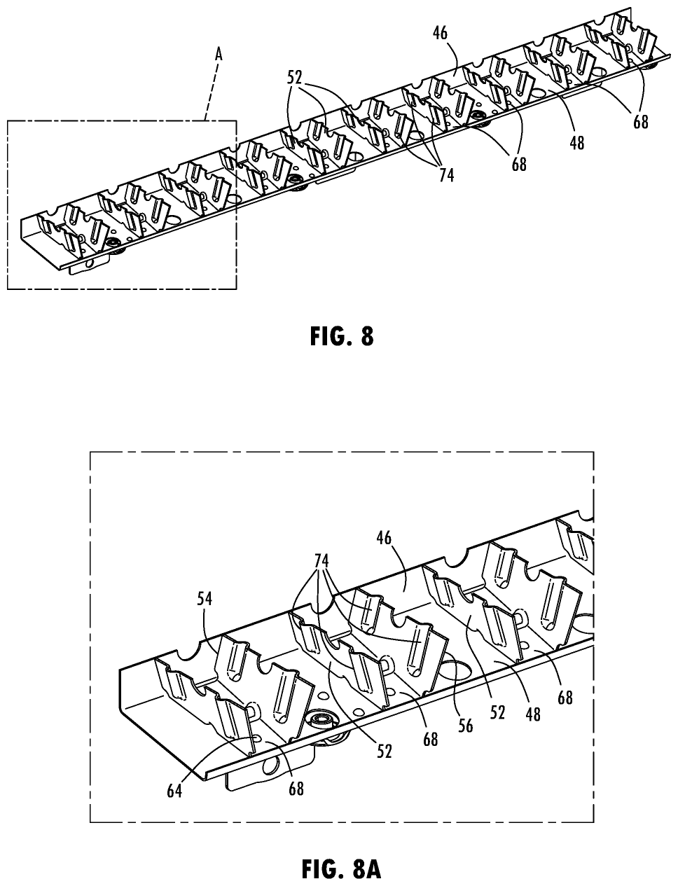

The stiffening member 42 includes features that may stiffen or initiate crush to provide certain performance characteristics of the rocker insert and overall rocker assembly in response to impact forces, such as a hole 72, a rib 74, and/or a dart or the like. As shown in FIGS. 7-9A, the stiffening member 42 includes a rib 74 that extends in a direction parallel to the length of the rocker insert 40, along a bulkhead wall section 52. The rib 74 extends on the bulkhead wall section 52 in a direction between the upper and lower wall sections 66, 68, as shown in FIG. 7, in parallel with the outer edge of the metal sheet that faces the outboard wall of the sill structure. As shown in FIGS. 7 and 8, the bulkhead wall sections 52 each include two ribs 74 that extends linearly in a direction extending between the upper and lower wall sections 66, 68. The rib 74 is shown as an elongated embossment, which may be formed with a stamping for the rib to extend orthogonal to the planar extent of the bulkhead wall section 52. The ribs 74 stiffen the bulkhead wall sections 52 in the direction they extend, which increase lateral stiffness of the section due to the tapered shape. In some examples, the ribs may be omitted or otherwise differently designed. In other examples, the rib is provided as a crush initiation feature. Accordingly, the ribs may be used to help tune the crush and load response of the system, such that different system requirements in additional examples may result in alteration to the design of these ribs. Further, in some implementations, the bulkhead wall sections include two or more ribs that extend in parallel between the upper and lower wall section.

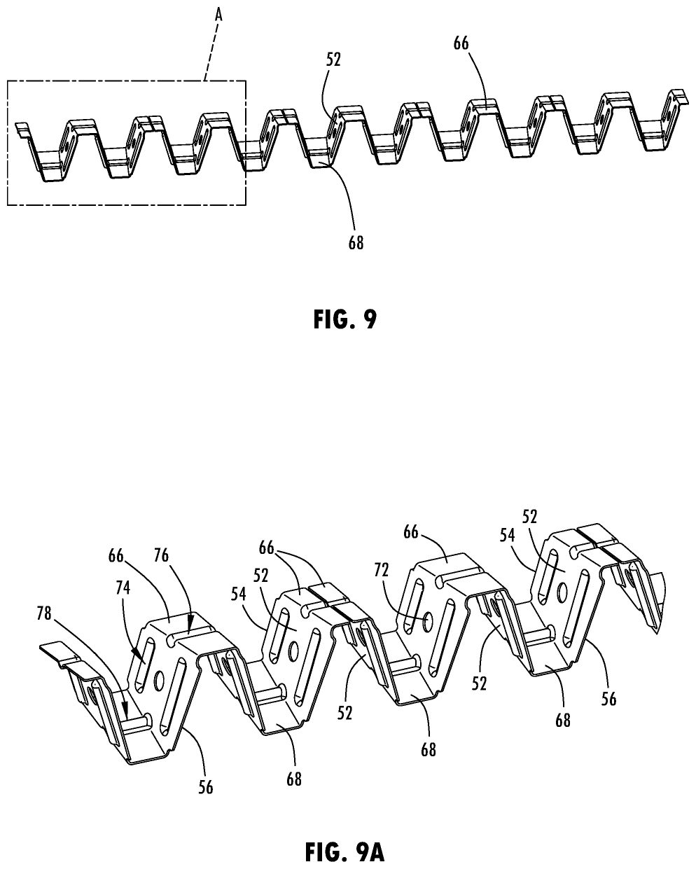

As further shown in FIGS. 8-9A, the upper and lower wall sections 66, 68 have an opposing tapered shaped that is opposite the tapered shape of the bulkhead wall sections 52, such that the upper and lower wall sections 66, 68 taper or otherwise decrease in size between the inner edge 72 of the metal sheet and the outer edge 70 of the metal sheet. The top and bottom wall sections 66, 68 may each include a rib or tuning channel 76, 78 that extends in a longitudinal direction along the length of the stiffening member 50. The tuning channels 76, 78 have a depth that extends into the bends that divide the top and bottom wall section from the bulkhead wall sections 52, such as to increase the robustness and stiffness of at bends. However, in some examples, the tuning channels may be omitted or otherwise differently designed. For example, the tuning channels may be used to help tune the crush and load response of the system, such that different system requirements in additional examples may result in alteration to the channels.

The stiffening member, as shown in FIG. 6, is disposed along the entire length of the rocker insert, and in additional examples may extend along a selection portion of the length of the rocker insert, such as more than 50% of the length of the rocker insert or more than 80% or the length of the rocker insert. The top and bottom wall sections 44, 46 of the support member 42 are configured to be supported by the elongated support member 42 when undergoing the inboard lateral impact force to increase lateral bending strength of the rocker insert. In other words, the integration of the support member with the elongated support member, in the configuration as described, provides a cooperative structural effect that increases lateral bending strength of the rocker insert leading to a lower failure risk or buckling threshold of the rocker insert during the lateral impact force, which may in turn increase the battery package space, resulting vehicle range, and overall safety of the vehicle.

In addition, the stiffening member may be a single piece or segmented into multiple pieces that are attached in the channel of the first stiffening member of the rocker insert, which may also be a single piece or multiple segmented pieces. The stiffening member in the illustrated example is formed from a flat metal sheet, such as a steel alloy. The height, depth, and degree of tapered shape of the rocker insert and associated wave-shape reinforcement insert may vary in different examples. It is also contemplated that the depth and height of the rocker insert and associated wave-shape reinforcement insert may be variable along the rocker assembly.

Unless specified to the contrary, it is generally understood that additional implementations of the rocker component may have an opposite orientation from the examples shown and described, such as where the sill panels identified as an inner panel may be used as the outer panel and the sill panels identified as an outer panel may be used as the inner panel. The cross-sectional shape of the inner and outer panels may vary along the rocker, such as, for example, by flaring outward at the ends.

When designing the vehicle rocker assembly with a rocker insert disclosed herein, the outer dimensions of the vehicle rocker assembly may be reduced and the overall weight of the vehicle rocker assembly may be reduced while meeting the required impact and loading conditions. The rocker insert may span a partial section of the vehicle rocker assembly or the entire length of the rocker assembly, such as to extend beyond the rocker assembly into and to also reinforce an adjacent component. The rocker insert disclosed herein may comprise the entire vehicle component or may be joined to additional reinforcements or parts of the vehicle component, such as at desired sections of the vehicle component. Further, in some examples the rocker assembly may be embodied as a subassembly or as part of a corresponding vehicle component, such as a structural component or a battery tray component and as such may be designed to undergo various impact forces and to support and sustain different loading conditions.

Moreover, the rocker insert disclosed herein may be formed with one or more pieces of sheet material, such as by roll forming a metal sheet, to provide the structure with a relatively high strength (for shear and axial loading) and low weight in comparison to common rocker panels, such as to allow the still panels of the corresponding vehicle component (if provided) to use less material, occupy a smaller packaging space, and have greater flexibility in the outer shape design. The cross-sectional shape of different examples of the vehicle component and rocker insert may include various shapes and thicknesses for the desired application of the vehicle component.

It is also contemplated that the internal reinforcements of the disclosed vehicle rocker assembly may be incorporated in other types of structural beams, such as in frames and structures of automotive and marine vehicles, buildings, storage tanks, furniture, and the like. With respect to vehicle applications, the vehicle component disclosed herein may be incorporated with various applications of different structural components. The vehicle component may be designed to support and sustain different loading conditions, such as for supporting certain horizontal spans or axial loading conditions. Also, the vehicle component may be designed to undergo various impact forces, such as for the illustrated rocker assemblies, pillar structures, and the like. The cross-sectional geometry, material type selections, and material thickness within the cross-sectional profile of the vehicle component may be configured for such a particular use and the desired loading and performance characteristics, such as the weight, load capacity the beam, force deflection performance, and impact performance of the vehicle component.

For purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 15% of, within less than 5% of, within less than 1% of, and within less than 0.1% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A rocker assembly for a vehicle, the rocker assembly comprising:
a sill structure having an inboard wall and an outboard wall defining an elongated hollow interior therebetween; and
a rocker insert extending along the elongated hollow interior of the sill structure, the rocker insert comprising:
a stiffening member having a metal sheet defining a wave-shaped structure that includes upper wall sections, lower wall sections, and bulkhead wall sections integrally extending between the upper and lower wall sections;
wherein the bulkhead wall sections have a tapered shaped between an inner edge of the metal sheet facing the inboard wall of the sill structure and an outer edge of the metal sheet that faces the outboard wall of the sill structure.

2. The rocker assembly of claim 1, wherein the inner edges of the bulkhead wall sections have a height dimension that is greater than a height dimension of the outer edges of the bulkhead wall sections.

3. The rocker assembly of claim 1, wherein the upper and lower wall sections have an opposing tapered shaped that is opposite the tapered shape of the bulkhead wall sections, such that the upper and lower wall sections taper between the inner edge of the metal sheet and the outer edge of the metal sheet.

4. The rocker assembly of claim 1, wherein the bulkhead wall sections comprise a stiffening rib that extends linearly in a direction extending between the upper and lower wall sections.

5. The rocker assembly of claim 4, wherein the stiffening rib comprises an elongated embossment.

6. The rocker assembly of claim 1, wherein the bulkhead wall sections extend at an angle from the interconnected upper and lower wall sections that is greater than 90 degrees.

7. The rocker assembly of claim 1, wherein the rocker insert further comprises an elongated support member that attached along the upper wall sections and/or the lower wall sections of the stiffening member.

8. The rocker assembly of claim 7, wherein the elongated support member comprises a top wall that attaches along the upper wall sections of the stiffening member and a bottom wall that attaches along the lower wall sections of the stiffening member.

9. The rocker assembly of claim 7, wherein the elongated support member comprises a top wall that interfaces along the upper wall sections of the stiffening member and a side wall that interfaces along the outer edges of the bulkhead wall sections of the stiffening member.

10. The rocker assembly of claim 7, wherein the elongated support member comprises a top wall, a side wall, and a bottom wall that are integrally connected to define a channel, wherein the stiffening member is disposed along the channel of the elongated support member, and wherein the top and bottom walls are angled from each other to conform to the tapered shape of the bulkhead wall sections.

11. A rocker assembly for a vehicle, the rocker assembly comprising:
a sill structure having an inboard wall and an outboard wall defining an elongated hollow interior therebetween; and
a rocker insert extending along the elongated hollow interior of the sill structure, the rocker insert comprising:
an elongated support member having a top wall section, a side wall section, and a bottom wall section defining a channel; and
a stiffening member disposed in the channel and having a metal sheet defining a wave-shaped structure that includes bulkhead wall sections integrally extending between the top and bottom wall sections;
wherein the bulkhead wall sections have a tapered shaped between an inner edge of the metal sheet and an outer edge of the metal sheet that interfaces with the side wall section of the elongated support member.

12. The rocker assembly of claim 11, wherein the wave-shaped structure of the stiffening member includes upper wall sections and lower wall sections that integrally extend between respective upper and lower ends of the bulkhead wall sections.

13. The rocker assembly of claim 12, wherein the upper and lower wall sections have an opposing tapered shaped that is opposite the tapered shape of the bulkhead wall sections.

14. The rocker assembly of claim 12, wherein the bulkhead wall sections comprise a stiffening rib that extends linearly in a direction extending between the upper and lower wall sections.

15. The rocker assembly of claim 14, wherein the stiffening rib comprises an elongated embossment.

16. The rocker assembly of claim 12, wherein the bulkhead wall sections extend at an angle from the interconnected upper and lower wall sections that is greater than 90 degrees.

17. The rocker assembly of claim 11, wherein the outer edges of the bulkhead wall sections have a height dimension that is less than a height dimension of the inner edges of the bulkhead wall sections.

18. A rocker insert disposed within an elongated hollow interior defined between a sill inner and a sill outer, the rocker insert comprising:
a stiffening member having a metal sheet that includes integrally connected upper wall sections, lower wall sections, and bulkhead wall sections that are divided by bends so as to define a wave-shaped structure;
wherein adjacent pairs of the bulkhead wall sections extend away from each other at an angle from the upper and lower wall sections that is greater than 90 degrees; and
wherein the bulkhead wall sections have a tapered shaped from an inner edge of the metal sheet facing the inboard wall of the sill structure to an outer edge of the metal sheet that faces the outboard wall of the sill structure.

19. The rocker insert of claim 18, wherein the rocker insert further comprises an elongated support member having a top wall, a side wall, and a bottom wall that define a channel, wherein the stiffening member is disposed along the channel of the elongated support member, and wherein the top and bottom walls are angled from each other to conform to the tapered shape of the bulkhead wall sections.

20. The rocker insert of claim 18, wherein the inner edges of the bulkhead wall sections have a height dimension that is greater than a height dimension of the outer edges of the bulkhead wall sections, and wherein the upper and lower wall sections have an opposing tapered shaped that is opposite the tapered shape of the bulkhead wall sections, such that the upper and lower wall sections taper between the outer edge of the metal sheet and the inner edge of the metal sheet.
